(19) United States
(12) Patent Application Publication
(10) Pub. No.: US 2024/0286538 A1
(43) Pub. Date: Aug. 29, 2024

(54) Vehicle Underseat Cover and Interior Protection System

(71) Applicant: Kevin Carlton Orzechowski, Canton, GA (US)

(72) Inventor: Kevin Carlton Orzechowski, Canton, GA (US)

(21) Appl. No.: 18/587,863

(22) Filed: Feb. 26, 2024

Related U.S. Application Data
(60) Provisional application No. 63/448,129, filed on Feb. 24, 2023.

(51) Int. Cl. B60N 2/60; B60R 7/04

(52) U.S. Cl. CPC B60N 2/6009; B60N 2/6027; B60R 7/043

(57) ABSTRACT

A vehicle underseat cover for protecting the interior of vehicles with rear seats wherein the lower cushion of the rear seat folds upwards to provide additional cargo space within the cabin of the vehicle. The vehicle underseat cover has a variety of attachment mechanisms adapted for use in the underseat location of a vehicle and provides protection of the interior from dirt, pet hair, and debris while providing an easy to clean surface. The vehicle underseat cover also incorporates additional storage and 10 organizational features and extensions of material to provide additional protection to the vehicle floor, rear seat seating surfaces, and front seat backs.

### CROSS REFERENCE TO RELATED APPLICATIONS

The present application claims priority under 35 U.S.C.§ 119(e) from U.S. Provisional Application Ser. No. 63/448,129, filed Feb. 24, 2023, entitled “Vehicle Underseat Cover System for Interior Protection and Organization of Cargo,” the disclosure of which is hereby incorporated by reference herein in its entirety.

### FIELD OF THE INVENTION

The present invention relates generally to the field of automotive accessories. More specifically, the invention is in the subfield of interior automotive accessories.

### BACKGROUND OF THE INVENTION

Many vehicles in common usage today, including, though not limited to, pickup trucks, SUVs, and the like, have rear seats with a lower seat cushion that may be raised to allow a user access to rear seat floor space. This function allows a user to use the rear seat floor space for carrying large items, such as tools, gardening equipment, or other large and bulky articles while not soiling or damaging the seating surfaces of the rear seats. Users may also commonly place pets or other animals in this space, which have dirty or muddy paws, shed fur, and leave other mess or debris behind. As a result, users of these types of vehicles often must clean the rear seat floor area of dirt, debris, hair and other soil, which is time consuming, difficult, or may lead to irreversible damage to the rear seat floor, bottom of the rear seat, seat frame, mechanical or electrical connections, or other areas of the vehicle interior.

As such, there is a need in the art for a simple and effective device that may protect the underside of a seat, the car floor, the back of a front seat, or any combination thereof. This device should be easy to install, fit to the interior of the vehicle, and be both easy to clean and resistant to staining or damage.

### SUMMARY OF THE INVENTION

An aspect of an embodiment of the present invention provides an underseat cover for protecting the underside of the bottom seat cushion in the rear seat area of a vehicle and, optionally, the rear seat floor area or front seat back, as well. The underseat cover may be made of materials that are easily cleaned while installed on the rear seat lower cushion and may also be easily removed for machine washing or other cleaning procedures. The underseat cover may also include a number of additional features to provide storage, organization of items frequently carried in the vehicle, or to add additional interior protection or to facilitate cleaning the rear seat area.

### DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIGS. 1 and 2 provide schematic depictions of a portion of an exemplary embodiment of an underseat cover for protecting the interior of a vehicle.

FIGS. 3 and 4 provide schematic depictions of a portion of an exemplary embodiment of an underseat cover for protecting the interior of a vehicle.

FIGS. 5 and 6 provide schematic depictions of an exemplary embodiment of an underseat cover for protecting the interior of a vehicle.

FIGS. 7 and 8 provide schematic depictions of an exemplary embodiment of an underseat cover for protecting the interior of a vehicle installed on a vehicle seat.

FIG. 9 provides a schematic depiction of an exemplary embodiment of an underseat cover with additional organizing features.

FIGS. 10A and 10B provide schematic depictions of an integrated debris catch for an underseat cover for protecting the interior of a vehicle.

FIG. 11 provides a schematic depiction of a side storage receptacle for an underseat cover installed on a vehicle seat cushion.

FIGS. 12A-12D provide schematic depictions of various methods for attaching an underseat cover to the bottom of a vehicle seat cushion.

FIG. 13 provides a schematic depiction of an anchor system for attaching an underseat cover to the bottom of a vehicle seat cushion.

FIGS. 14A and 14B provide schematic depictions of a covering extension of an underseat cover for protecting the floor or seat cover of a vehicle interior.

FIG. 15 provides a schematic depiction of an underseat cover with a covering extension in a stowed position.

FIG. 16 provides a schematic depiction of an underseat cover with skirts for protecting the interior of a vehicle.

FIG. 17 provides a schematic depiction of an underseat cover with a covering extension configured to attach to a front seat in a vehicle interior.

FIG. 18 provides a schematic depiction of an underseat cover with a covering extension configured to cover the floor and back of a front seat in a vehicle interior.

### DETAILED DESCRIPTION OF EXEMPLARY EMBODIMENTS OF THE INVENTION

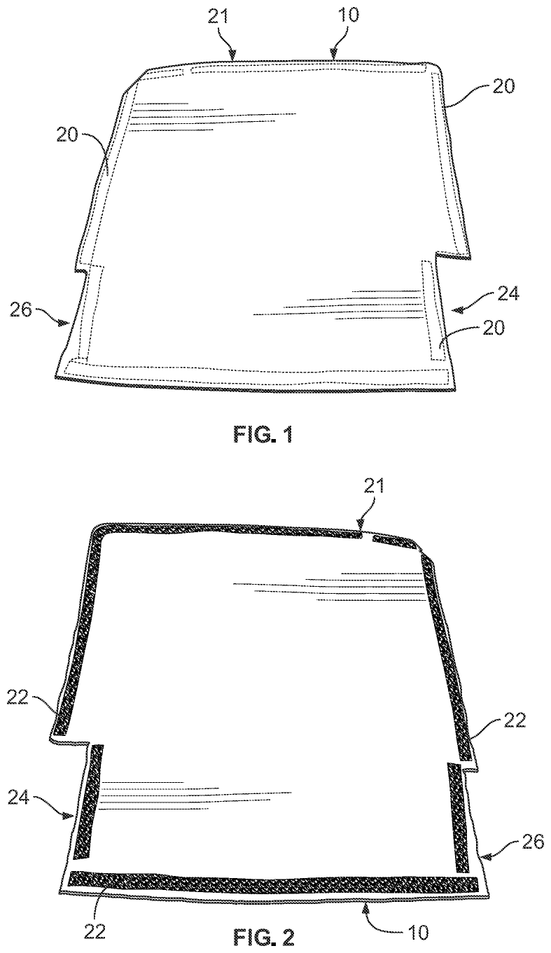

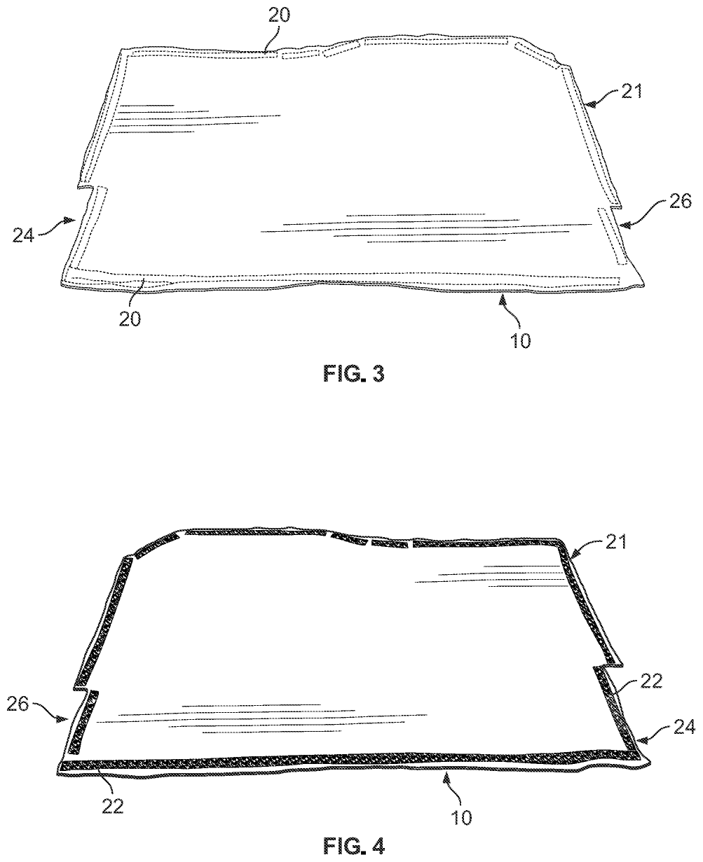

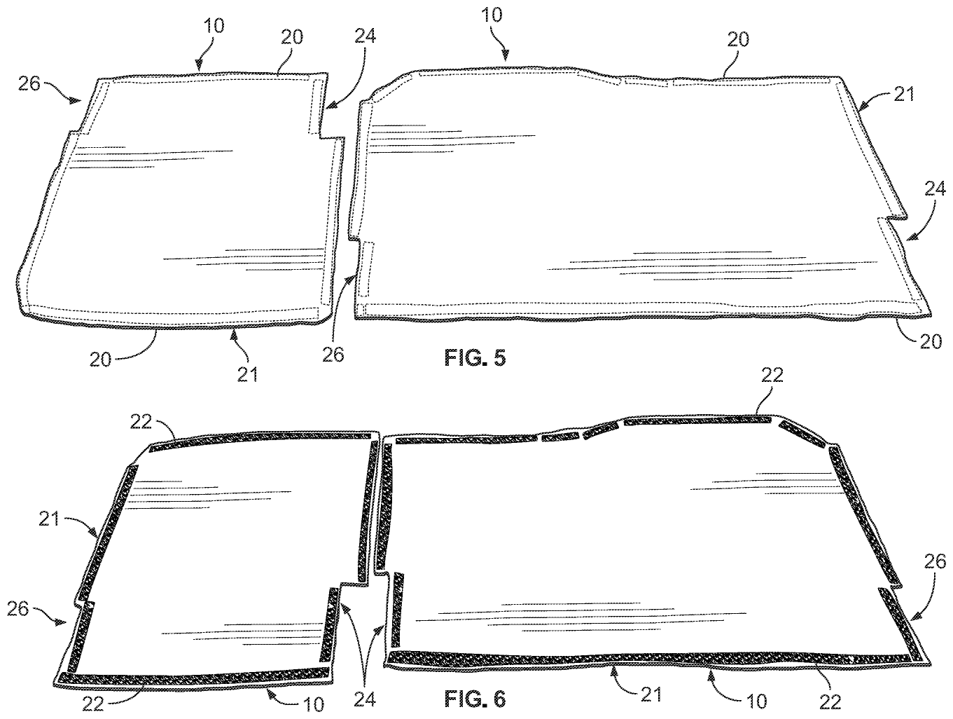

FIGS. 1-6 provide depictions of underseat covers 10 that are adapted for use on the bottom surface of the lower rear seat cushion of a pickup truck or similar vehicle. The underseat cover 10 may be trimmed, shaped, formed, or otherwise produced with a perimeter 21 or outline or contour that matches or closely matches the shape of the seat cushion that it is intended to fit with. The perimeter 21 or other areas of the underseat cover 10 may include features such as one or more seatbelt reliefs 24 or hinge reliefs 26 adapted or configured to fit the underside of the seat cushion around seatbelts or seat hinges or frame structures, respectively, or other shaping or reliefs to accommodate seat frames, or other items in the vehicle interior which the underseat cover 10 must fit around, over, or otherwise interface with. It should be appreciated that the underseat cover 10 may be trimmed, shaped, formed, or otherwise produced with a contour for a specific model of vehicle, or the underseat cover 10 may be produced with a perimeter 21 in generic shapes, sizes, or contours to fit a variety of vehicles. In certain embodiments, the underseat cover 10 may be provided to the user as a kit that allows for trimming of the underseat cover 10 to match a particular vehicle application. As shown in FIGS. 5 and 6, the underseat cover 10 may be formed or otherwise provided in two or more parts, each with its own respective perimeter 21, to accommodate split folding rear seats and allow for full coverage while retaining the split folding functionality with the underseat cover 10 installed.

Still referring to FIGS. 1-6, the underseat cover 10 may include one or more attachment mechanisms such as hook strips 22 attached or otherwise affixed to the underseat cover 10 through reinforcement stitching 20. The hook strip 22 may feature the hook portion of a hook and loop fastener, which may engage with the carpeting or other material commonly found on the bottom portion of fold-up rear seat cushions. The hook strips 20 may then removably affix the underseat cover 10 to the bottom of the rear seat cushion to protect the rear seat bottom from dirt, debris, pet hair, or other soiling materials. In certain embodiments, the hook strip 22 may be adhered to the underseat cover 10 in any number of ways. For example, the hook strip 22 may be bonded with, sewn to, or otherwise attached or integrated into the underseat cover 10 in locations that may or may not correspond to any reinforcement stitching 20. While illustrated herein as an underseat cover 10 having a perimeter 21 with reinforcement stitching 20 and hook strips 22, it should be appreciated that the hook strips 22 may be placed in any number of configurations or arrangements about the underseat cover 10 to provide adequate hold or adaptability to different shapes, sizes, or configurations of lower rear seat cushions. For example, the underseat cover 10 may include additional hook strips 22 in the middle or in other areas of the underseat cover 10 to add additional attachment points or additional holding strength for the underseat cover 10 when installed. In embodiments wherein the user may trim the underseat cover 10 for a particular vehicle application, the underseat cover 10 may include a number of hook strips 22 located in commonly acceptable locations for popular applications so that the user may trim off portions of the underscat cover 10 and retain adequate hook strips 22 for securing the underseat cover 10. In other embodiments, the underseat cover 10 may come with hook strips 22 with a glue or otherwise sticky or tacky backing to allow the user to trim the underseat cover 10 and then apply the hook strips 22 in the necessary locations for the particular vehicle application. It should be appreciated that the underseat cover 10 may also be provided or produced with other mechanisms of attachment to secure it to the lower cushion of the vehicle seat as shown below. For example, the underseat cover 10 may also attach to the lower cushion of an automotive seat through straps, snap buttons, buckles, zippers, or magnetic attachment to complementary magnets, to magnetic materials in the seat frame, or any combination thereof.

The underseat cover 10 may also include reinforcement stitching 20 around all or a portion of the perimeter 21 of the underseat cover 10 regardless of the attachment mechanism or the location of any hook strips 22. For example, the underseat cover 10 may include reinforcement stitching 20 around the edges of the panel of protective material such that the underseat cover 10 is more durable and less likely to fray or split. Furthermore, the underseat cover 10 may have a rolled edge at the perimeter 21 to allow the reinforcement stitching 20 to provide a thicker material around perimeter 21. In still further embodiments, the underseat cover 10 panel of protective material may be a single layer or multiple layers of similar or dissimilar materials, which may be secured to one another with the reinforcement stitching 20. However, it should be appreciated that multiple layers of material may be bonded or secured to one another or stitched together separate from any reinforcement stitching 20.

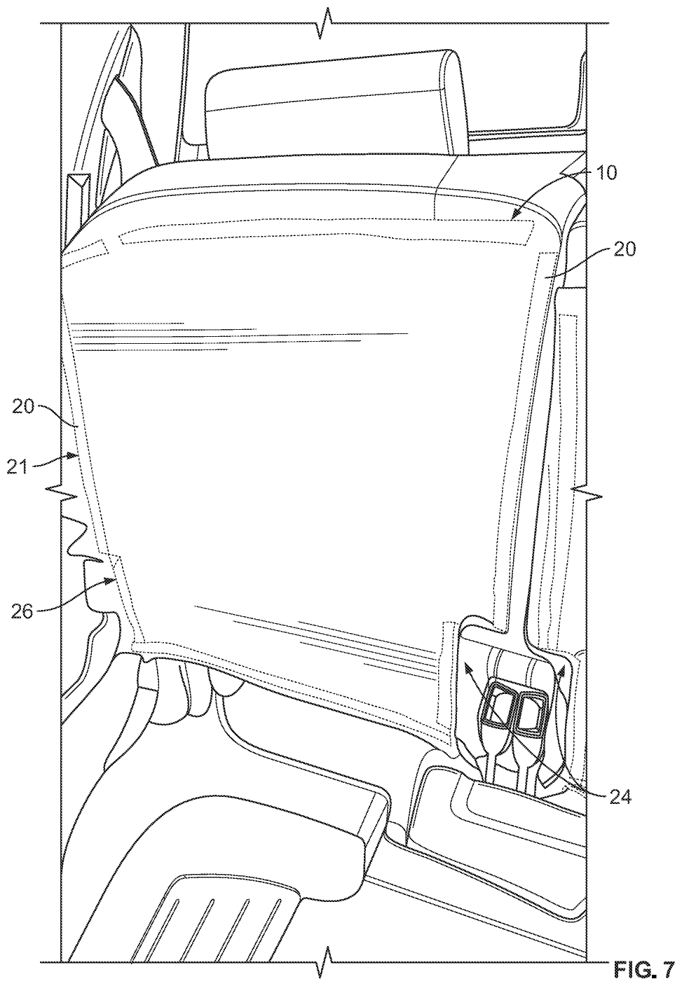

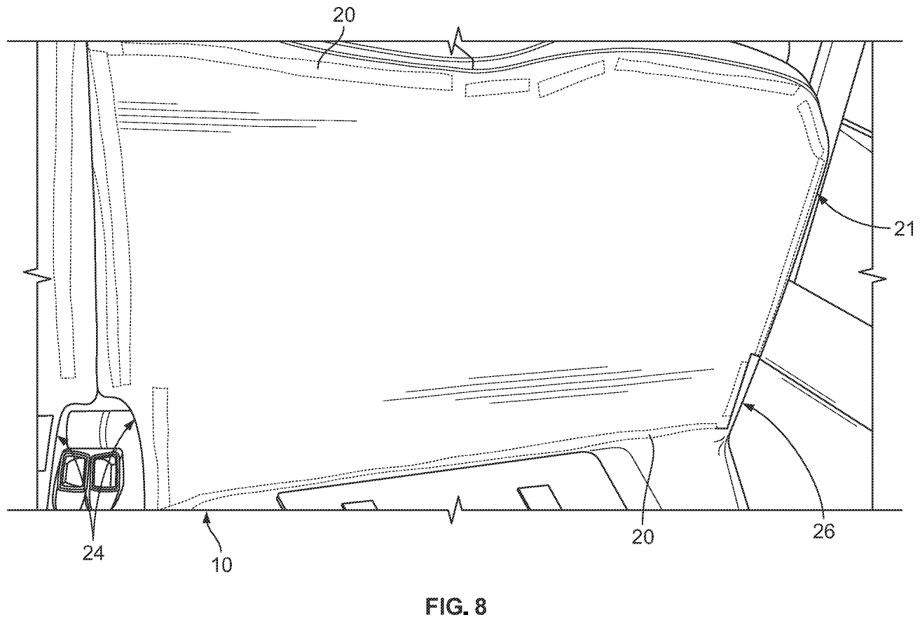

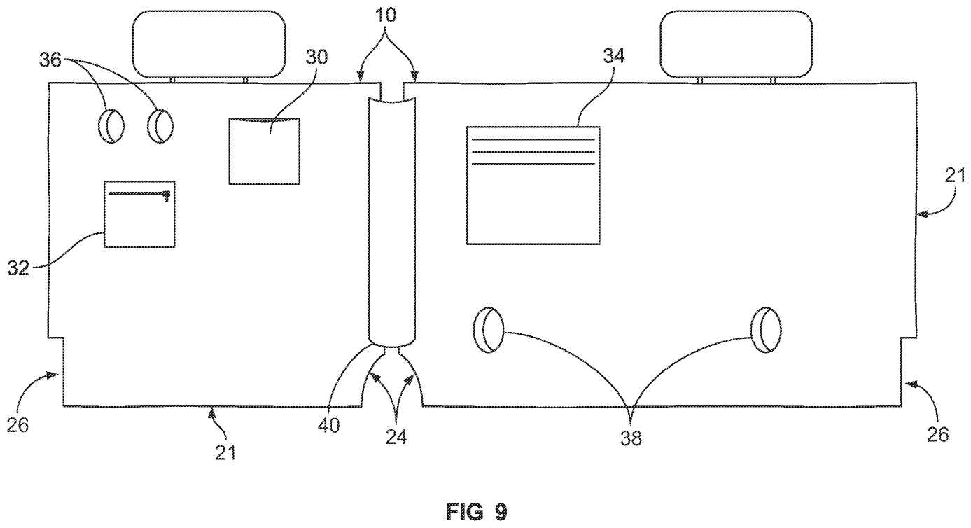

FIGS. 7 and 8 provide depictions of an underseat cover 10 installed on the bottom portion of a rear seat cushion in a vehicle. The underseat cover 10, which includes reinforcement stitching 20 to attach or otherwise affix hook strips, is affixed to the carpeting on the lower face of the rear seat cushion through the engagement of the hook strips with the lower rear seat cushion carpeting. The perimeter 21 of the underseat cover 10 includes one or more seatbelt reliefs 24 to clear seatbelt buckles. Similarly, the perimeter 21 of the underseat cover 10 may include one or more hinge reliefs 26 to clear hinges or other structural components of the rear seat cushion in a vehicle. The underseat cover 10 may then protect the lower face of the rear seat cushions when the cushions are folded up and the rear seat area is used for carrying cargo, pets, or the like. When not in use, the user may lower the rear seat cushion with the underseat cover 10 installed and use the seat in a conventional manner without the need to remove or otherwise manipulate the underseat cover 10. It should be appreciated that the perimeter 21 of the underseat cover 10 may take on a shape that is complementary or substantially the same as the perimeter of the lower seat cushion of a rear seat in a particular vehicle or application.

FIG. 9 provides a schematic depiction of an underseat cover 10 with a number of optional cargo-organizing features installed on a rear seat with the cushions in a folded position. As shown, the underseat cover 10, which may comprise a panel of protective material with a perimeter 21, one or more seatbelt reliefs 24, and one or more hinge reliefs 26, may include or incorporate any number or arrangement of optional organizing features that allow it to function as an organizer or otherwise store items that may be routinely carried in the vehicle. For example, the underseat cover 10 may include one or more pockets 30 or zippered pockets 32 for storing and holding small items. In certain embodiments, the underseat cover 10 may also include one or more file folder pockets 34 adapted for holding or carrying documents, document folders, or other papers. The underseat cover 10 may also incorporate one or more small item loops 36 or large item loops 38. Small item loops 36 may be used to carry small items, such as tools or smaller firearms, and may be placed closer together to allow multiple small item loops 36 to secure a small, yet heavy, item. Similarly, large item loops 38 are adapted or otherwise configured to secure larger items, such as construction or lawn tools, long firearms, or other similar items. It should be appreciated that the large item loops 38, small item loops 36, or both, may be clastic or otherwise flexible in nature to stretch over an item to be secured. In certain embodiments, the large item loops 38, small item loops 36, or both, may include loops which are split or otherwise separable with hook and loop fasteners, buttons, buckles, magnets, or other connection mechanisms to allow the loops to be opened, placed around an item to be secured, and then closed around that item. It should be appreciated that large item loops 38, small item loops 36, or both, may include buckles or other mechanisms to adjust the overall circumference of the loop or the length of the individual pieces of the loop to secure items of varying sizes.

Still referring to FIG. 9, the underseat cover 10 may also incorporate a debris catch 40 located between the two portions of the underseat cover 10. It should be appreciated that the underseat cover 10 may be a single piece or multiple pieces to accommodate different types of rear seats, including bench seating, split folding bench seating, or individual seats. This debris catch 40 may be a panel or portion of fabric or other material configured to extend between the two portions of the underseat cover 10, and subsequently be positioned under the gap between the two portions of a split lower rear cushion of the rear seat often found in vehicles. The debris catch 40 may then catch crumbs, dirt, debris, or other items or material that fall between the split rear seat cushions and trap it for easy cleaning and removal from the vehicle. The debris catch 40 may be permanently affixed to one portion of the underseat cover 10 and removably affixed to the other portion of the underseat cover 10, or it may be removably affixed to both portions of the underseat cover 10. For example, the debris catch 40 may be secured with stitching, glue, or other permanent or semi-permanent means to one portion of the underseat cover 10 and removably attached or affixed to the other portion of the underseat cover 10 with hook and loop fasteners, snap buttons, buckles, zippers, magnets, or other attachment mechanisms. The debris catch 40 may then be detached from the underseat cover 10 along this removable attachment point for cleaning, removal of trapped debris or items, or to allow independent folding and articulation of the split lower rear seat cushion. It should be appreciated that the debris catch 40 may also be removably attached as described to both portions of the underseat cover 10 to be completely removed for collection of debris or cleaning.

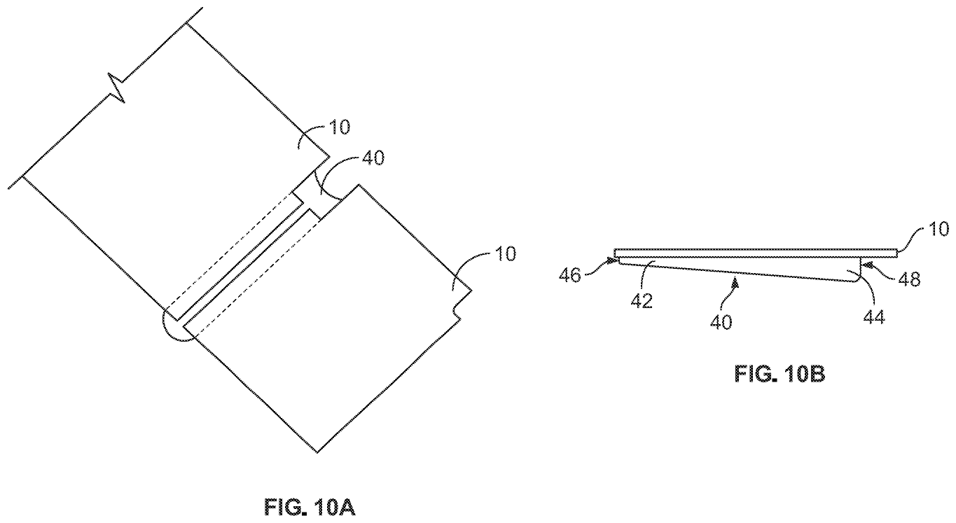

FIGS. 10A and 10B provide additional views of the debris catch 40 mounted to an underseat cover 10. The debris catch 40 may include a shallow end 42 and a deep end 44 wherein the shallow end 42 of the debris catch 40 extends below the underseat cover 10 to a lesser degree than the deep end 44. The differing relative extension of the debris catch 40 at the shallow end 42 and the deep end 44 provides a sloped contour to the debris catch 40. This sloped contour of the debris catch 40 serves to collect any debris, dirt, crumbs, or small items near the deep end 44 of the debris catch 40. Furthermore, in the case of a debris catch 40 which has a rear panel 48, the debris catch 40 will continue to hold any debris, dirt, crumbs, or small items caught within the debris catch 40 when the rear seat cushion is folded up as the rear panel 48 will prevent the debris, dirt, crumbs, or small items from falling out of the debris catch 40. Similarly, the debris catch 40 may also include an optional front panel 46 to further secure any debris, dirt, crumbs, or small items which fall into the debris catch 40.

Referring to FIGS. 9-10B, it should be appreciated that the one or more organizational features 30, 32, 34, 36, 38 and the debris catch 40 may be incorporated into any underseat cover 10 as shown in any embodiment described herein.

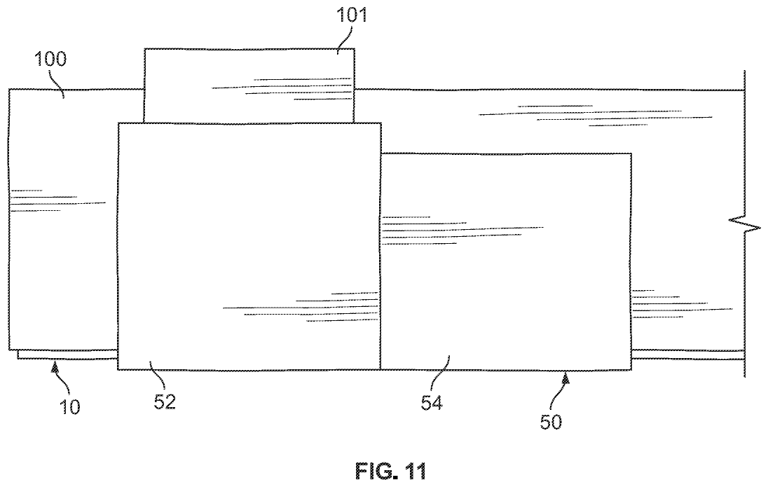

FIG. 11 provides a schematic depiction of an underseat cover 10 installed on the lower seat cushion 100 of the rear seat of a vehicle. The underseat cover 10 may include or incorporate additional features to allow it to hold, store, or secure items when the lower seat cushion 100 is down and available for seating. For example, the underscat cover 10 may include a side storage unit 50, which may comprise a cup holder 52 adapted to securely hold a beverage container 101, storage receptacle 54, or both, that is adapted or otherwise configured to be positioned on the side or front of the lower seat cushion 100. This provides additional storage or beverage holding options to back seat passengers and is supported by the attachment of the underseat cover 10 to the lower seat cushion 100.

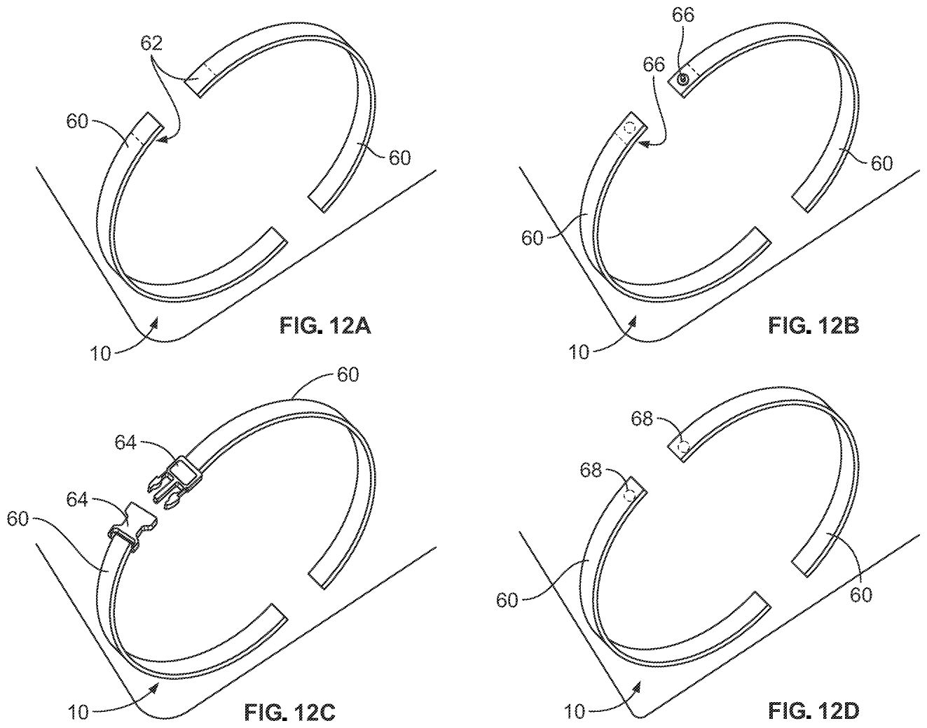

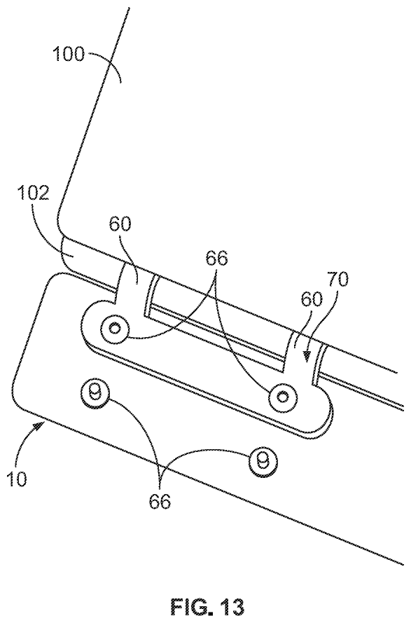

FIGS. 12A-12D and 13 provide schematic depictions of various alternative attachment mechanisms for attaching the underseat cover 10 to the bottom of a lower rear seat cushion. As shown in FIGS. 12A-12D, the underseat cover 10 may include one or more attachment straps 60 which may be placed around or about the lower frame of the rear seat cushion to attach or otherwise affix the underseat cover 10 to the cushion. These attachment straps 60 may be elastic or otherwise flexible to allow for wrapping around the lower frame of the rear seat cushion. These attachment straps 60 may include any number of closing mechanisms that allow for the attachment straps 60 to secure to one another and provide an anchoring function of the underseat cover 10 to the lower rear seat cushion. For example, in FIG. 12A, the attachment straps 60 may include complementary portions of a hook and loop fastener 62 for securing the attachment straps 60 to one another. In FIG. 12B, the attachment straps 60 may also include complementary snap buttons 66 for affixing or attaching both attachment straps 60 to one another. The attachment straps 60 may also include buckles 64, as depicted in FIG. 12C, for connection of the attachment straps 60 to one another and securing the underseat cover 10 to the lower portion of the rear seat cushion. As shown in the exemplary embodiment of FIG. 12D, the attachment straps 60 may include one or more magnets 68 which may secure the attachment straps 60 to one another when the magnets 68 are brought into close proximity to one another. In certain embodiments, the magnets 68 may be embedded within the attachment straps 60 so they are not visible, while in still further embodiments the magnets 68 may be exposed to provide more secure attachment or to allow a user to more accurately place the magnets 68 for securing the attachment straps 60. The attachment straps 60 may also be directly mounted to any framing or structure under the rear seat of a vehicle that are made from ferrous metal or otherwise magnetic materials. It should be appreciated that the attachment straps 60 may include one or more mechanisms for adjusting the overall length of the attachment straps 60 to allow for fitment over varying sizes of rear seat lower cushion frames. For example, the portions of hook and loop fastener 62 shown in FIG. 12A may extend along all or a portion of the length of the attachment straps 60 to allow for different placement of the attachment straps 60 and tightening or loosening the resulting loop. In certain embodiments, the attachment straps 60 may include buckles or other features for lengthening or shortening the attachment straps 60 to provide adjustability in the length of the attachment straps 60 for fitment to a wide variety of lower rear seat cushion frames.

Referring to FIG. 13, the underseat cover 10 may incorporate or otherwise include an anchor 70 for allowing the underseat cover 10 to be quickly and easily removed from the lower rear seat cushion 100 for cleaning or replacement. The anchor 70 may feature one or more attachment straps 60 or other attachment means, such as the hook portion of a hook and loop fastener, for securing the anchor 70 to the lower seat cushion frame 102 or the material on the lower seat cushion 100. The anchor 70 may then incorporate a release mechanism such as snap buttons 66 or other features which are complemented by snap buttons 66 or other complementary features on the underseat cover 10 to releasably secure the underseat cover 10 to the anchor 70, and subsequently the lower seat cushion frame 102 or lower seat cushion 100. The underseat cover 10 may then be mounted to the lower rear seat cushion 100 by securing the complementary snap buttons 66, and releasably securing the underseat cover 10 to the anchor 70. It should be appreciated that the underseat cover 10 may be affixed or otherwise attached to the anchor 70 through any number of release mechanisms including snap buttons 66, hook and loop fasteners, zippers, buckles, magnets, or any other structure that allows the underseat cover 10 to be easily attached and detached from the anchor 70. Similarly, the anchor 70 may mount to the lower rear seat cushion frame 102 through attachment straps 60 with hook and loop fasteners, snap buttons, buckles, magnets, or other mechanisms as shown relative to the attachment straps 60 of FIGS. 12A-12D. It should be appreciated that the anchor 70 may also mount to the lower seat cushion 100 or the seat frame 102 through the hook side of a hook and loop fastener affixed or otherwise attached to the material commonly found on the bottom of a seat cushion 100 in automotive or other vehicular applications, as described with reference to FIGS. 1-8 above.

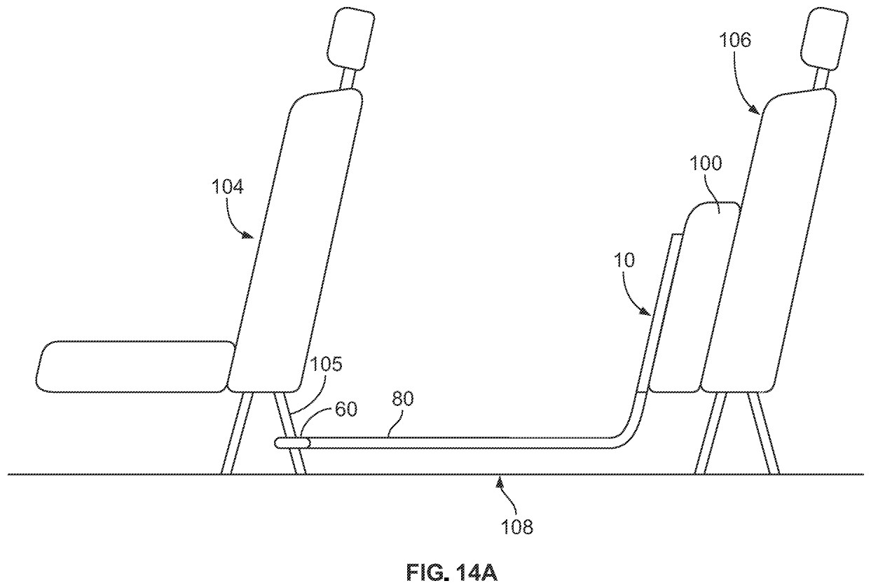

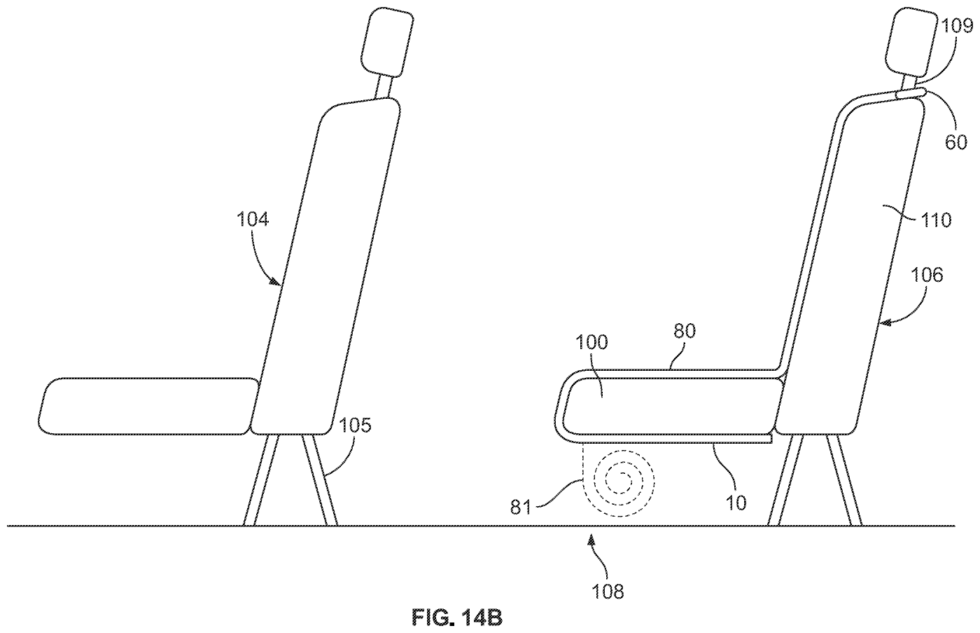

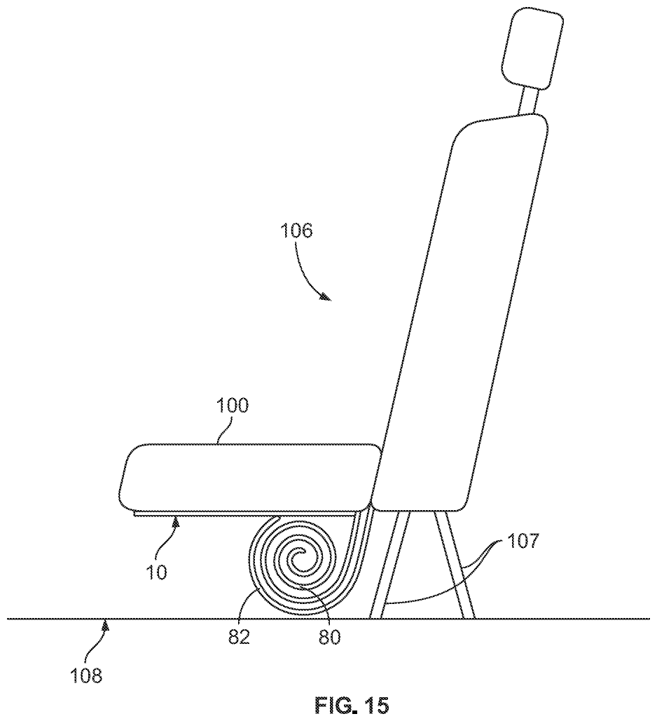

FIGS. 14A, 14B, and 15 provide depictions of an underseat cover 10 with an integrated cover extension 80 for protecting the floor or seating surfaces of the rear seat area of a vehicle. Referring to FIGS. 14A and 14B, the underseat cover 10, which may be mounted to the lower side of the lower cushion 100 of a rear seat 106, may include a cover extension 80 configured to cover the vehicle floor 108 in the space between the rear seat 106 and front seat 104. The floor cover or cover extension 80 may include one or more attachment straps 60 or other attachment mechanisms to secure the floor cover or cover extension 80 to the front seat mounts or framing 105 to prevent rolling, folding, or bunching of the cover extension 80. It should be appreciated that the attachment straps 60 may be affixed or otherwise attached to the front seat mounts 105 with hook and loop fasteners, snap buttons, buckles, magnets, or any other attachment means as described above with reference to attachment straps 60. Similarly, the cover extension 80 may be affixed or otherwise attached to the front seat mounts 105 through one or more anchors as described above in FIG. 13. In certain embodiments, the cover extension 80 may include a weighted edge, weighted strip, or weights at the edge of the cover extension 80 to prevent movement or motion of the cover extension 80 when in use In certain embodiments, the weighted edge, weighted strip, or weights at the edge of the cover extension 80 may secure the cover extension 80 in position without the need for attachment straps 60 or other attachment mechanisms.

Referring specifically to FIG. 14B the cover extension 80 may also be flipped up and over the seating surface of the rear seat 106 when the lower cushion 100 is in a lowered position to protect the seating surface from dirt, mud, debris, pet hair, or other soiling materials when a user places dirty items, such as gardening tools or sports equipment, or pets in the rear seat area. The cover extension 80 may be held in place by the attachment straps 60 or other securing mechanisms, such as the attachment mechanisms described in FIGS. 12A-12D or the anchor described in FIG. 13, to attach or affix to the seat frame at the junction of the upper seat cushion 110 and lower seat cushion 100, or the cover extension 80 may attach to a headrest support 109, headrest, or other portion of the seat or seat frame at the top of the rear seat 106. It should be appreciated that in certain embodiments, the cover extension 80 may be affixed or attached to the underseat cover 10 at the rear edge of the lower cushion 100 (as shown in FIG. 14A), or it may be attached to the underseat cover 10 at the front edge of the lower cushion 100 (as shown in FIG. 14B), and may be used to protect either the vehicle floor 108 or seating surfaces of the rear seat 106 regardless of the attachment position of the cover extension 80 to the underseat cover 10. In certain embodiments, the cover extension 80 may be detachable from the underseat cover 10 and may be affixed or otherwise attached to the underseat cover 10 by a variety of means including hook and loop fasteners, zippers, snap buttons, buckles, or magnetic fasteners. In still further embodiments, the cover extension 80 may be moved by the user between multiple attachment positions on the underseat cover 10, including at the front of the seat cushion 100, the rear of the seat cushion 100, or in any location in between. Furthermore, the cover extension 80 may still be rolled, folded, or otherwise put into a stowage position 81 regardless of attachment position in a manner similar to that described below with reference to FIG. 15.

Referring to FIG. 15, when the lower cushion 100 of the rear seat 106 is in a lowered and deployed position for seating, the cover extension 80 may be rolled, folded, or otherwise compacted to fit underneath the lower cushion 100 of the rear seat 106 for stowage purposes. The cover extension 80 may then be held in place with one or more securing means including, but not limited to, securing straps 82, which wrap around the cover extension 80 and maintain it in a stowed position. In certain embodiments, the cover extension 80 may incorporate hook and loop fasteners, straps, snap buttons, buckles, zippers, magnets, or other fastening means to attach the leading or free edge of the cover extension 80 to the underseat cover 10 or to itself for securing it in a stowed position. It should be appreciated that the cover extension 80 may also be kept in a deployed position even when the lower seat cushion 100 of the rear seat 106 is available for seating to provide protection to the vehicle floor 108 from dirt, mud, debris, pet hair, and other soiling materials. It should be appreciated that in the stowed position, the cover extension 80 may provide a barrier to debris, dirt, or other material that may interfere with the rear seat mount or framing 107 or any mechanical or electrical components located below the rear seat 106.

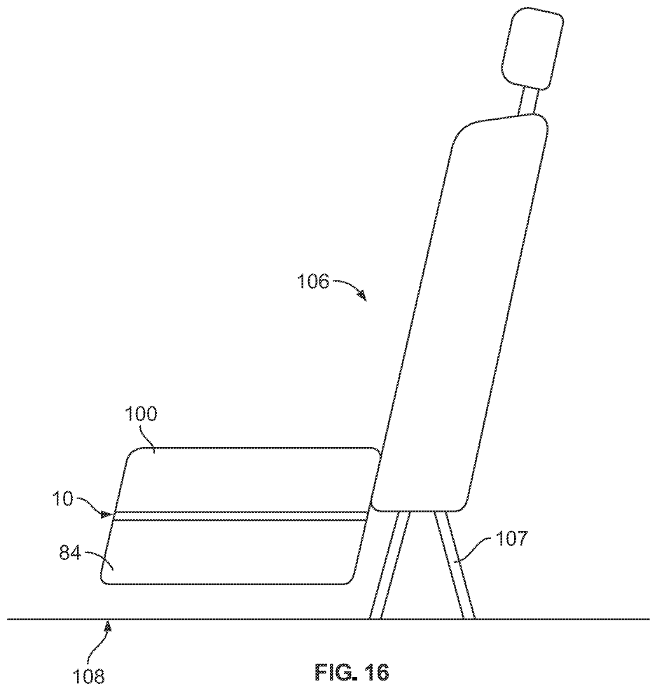

FIG. 16 provides a schematic depiction of an underseat cover 10 installed on the lower seat cushion 100 of a rear seat 106. The underseat cover 10 may include or incorporate a skirt 84 or extra piece of material that extends down from the underseat cover 10 to prevent dirt and debris from moving or being distributed beneath the lower rear seat cushion 100. The skirt 84 may then facilitate casier cleaning of the rear seat area and prevent dirt and debris from becoming entrained in the rear seat frame 107, joints, hinges, electrical connectors, or other equipment under the rear seat 106. In certain embodiments, the skirt 84 may have an attachment strip such as a weighted edge or a strip of the hook material of a hook and loop fastener to maintain the free edge of the skirt 84 in close proximity or in contact with the vehicle floor 108. It should be appreciated that the skirt 84 may also be attached or otherwise affixed to the vehicle floor 108 with attachment straps or anchors as described above. Furthermore, the skirt 84 may be removably affixed to the underseat cover 10 through the use of hook and loop fasteners, snap buttons, buckles, zippers, magnets, or other attachment means in a manner similar to the debris catch 40 or cover extension 80 described above.

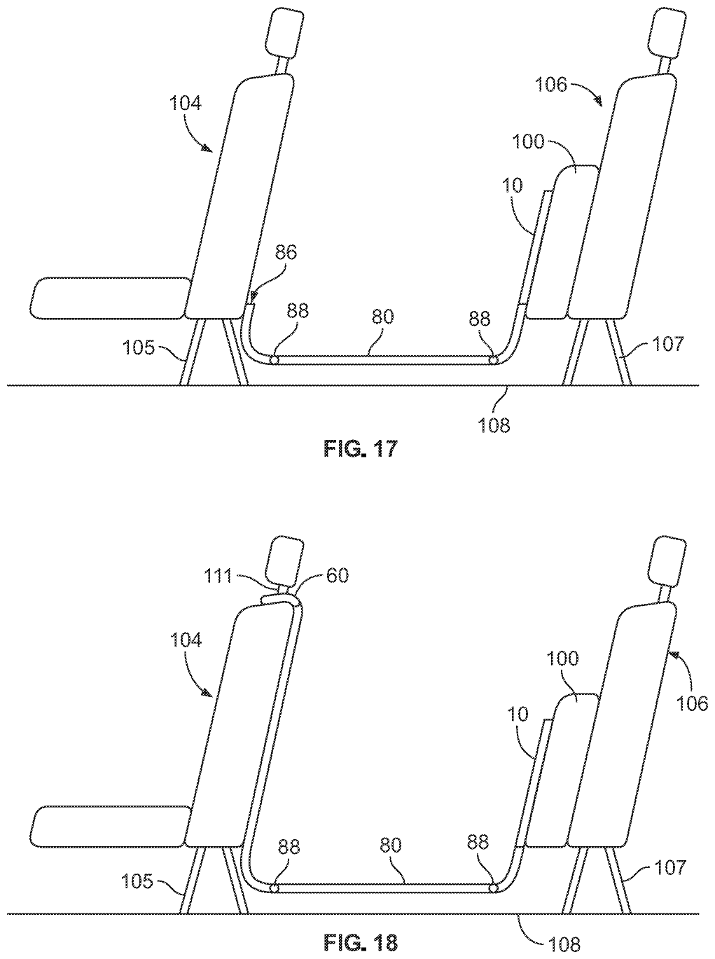

FIGS. 17 and 18 provide schematic depictions of an underseat cover 10 with a cover extension 80 that is adapted for covering the vehicle floor 108 and attaching to the front seat 104 in a vehicle to provide additional protection of the vehicle interior. As shown, the underseat cover 10 is affixed or otherwise attached to the bottom of the lower seat cushion 100 of the rear seat 106. The cover extension 80 extends from the underseat cover 10, across the vehicle floor 108, and to the rear of the front seat 104. The cover extension 80 may include one or more attachment strips 88 positioned such that they will maintain the cover extension 80 in close proximity with or attached to the vehicle floor 108 and prevent bunching, sliding, or lifting of the cover extension 80, which may present a tripping hazard to occupants or pets getting into or out of the vehicle. It should be appreciated that the cover extension 80 with attachment strips 88 to keep the cover extension 80 in close proximity to, or attached to, the vehicle floor 108 provides additional protection to the front seat mount 105, rear seat mount 107, and any other mechanical hinges, joints, electrical connectors, sensors, or other equipment located underneath the front seat 104 or rear seat 106. In certain embodiments, the attachment strips 88 may comprise a weighted strip or series of weights to secure the cover extension 80 in proximity or connection to the vehicle floor 108. In still further embodiments, the attachment strips 88 may comprise the hook portion of a hook and loop fastener to attach or secure the cover extension 80 to carpeting or covering materials commonly found in automotive seating or interior applications.

Referring specifically to FIG. 17, the cover extension 80 may have a cover attachment mechanism 86 at the free end of the cover extension 80 affixed or otherwise attached to the seat back of the front seat 104. The free edge of the cover extension 80 may be removably affixed or attached to the front seat 104 through a number of cover attachment mechanisms. For example, the cover attachment mechanism 86 may comprise the hook portion of a hook and loop fastener, similar to that of the underseat cover 10 as shown in FIGS. 1-6. In certain embodiments, the cover attachment mechanism 86 may comprise an anchor as described with reference to FIG. 13, wherein an anchor is secured to the rear portion of the front seat 104 and then a release mechanism may be used to attach and detach the cover extension 80 from the anchor, and subsequently, the front seat 104.

Referring specifically to FIG. 18, the cover extension 80 may extend up the back of the front seat 104 and attach or secure itself by attachment straps 60 or other securing mechanisms, such as the attachment mechanisms described in FIGS. 12A-12D or the anchor described in FIG. 13 to attach or affix to a front seat headrest support 111, headrest, or other portion of the seat or seat frame at the top of the front seat 104. In such an embodiment, the entire load area in the rear of the vehicle cabin is protected from dirt, debris, pet hair, or other soiling materials, and the cover extension 80 will stay in close proximity or attached to the vehicle floor 108 because of the attachment strips 88.

Referring to FIGS. 1-18, the underseat cover 10 and any of its associated parts or attachments may be made, formed, or produced from a wide variety of materials.

Materials may include, but are not limited to, vinyl, pleather, leather, plastic, rubber or elastomer materials, fabric, or any other material which may provide protection and case of cleaning. For example, the underseat cover 10 may be produced from non-permeable materials such as, but not limited to, vinyl, synthetic leather, treated leather, plastic, or rubber to provide a moisture barrier between the vehicle interior and items or pets which may be wet, muddy, or from pet messes or bodily fluids. Impermeable materials may also facilitate wiping down of the underseat cover 10, cover extension 80, or the like. Alternatively, the underseat cover 10 or any of its parts or attachments may also be made from fabrics or other materials that are easily removed and washed in a washing machine or otherwise easily cleaned. For example, the underseat cover 10, cover extension 80, or any of their components may be made from nylon, microfiber, or any number of other fibers which easily shed pet hair, dirt, debris, or other soiling materials. Furthermore, it should be appreciated that the hook material used to attach or affix various parts of the underseat cover 10, or other components, to carpeting or fabric commonly used in automotive interiors may comprise any material with a texture, surface, fibers, or other features that allows the hook material to engage with, intertwine with, or otherwise interface with carpeting or other fabric.

In summary, while the present invention has been described with respect to specific embodiments, many modifications, variations, alterations, substitutions, and equivalents will be apparent to those skilled in the art. The present invention is not to be limited in scope by any of the specific embodiments described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. An underseat cover for folding seat bottoms comprising:
a panel of protective material having a first side, a second side, and a perimeter;
reinforcement stitching;
an attachment mechanism; and
a first relief cutout;
wherein said perimeter of said panel of protective material is configured to substantially match a perimeter of a rear seat lower cushion bottom, said reinforcement stitching in communication with said first side of said panel of protective material and proximate to at least a portion of said perimeter, said attachment mechanism in communication with said second side of said panel and in communication with said reinforcement stitching.

2. The underseat cover of claim 1, wherein said first side of said panel of protective material comprises a non-permeable material.

3. The underseat cover of claim 1, wherein said first relief cutout is configured to clear a seatbelt buckle.

4. The underseat cover of claim 3, further comprising a second relief cutout;
wherein said second relief cutout is configured to clear a folding seat bottom hinge.

5. The underseat cover of claim 1, further comprising at least one organizing feature;
wherein said at least one organizing feature is selected from the group consisting of a pocket, a zipped pocket, a file pocket, one or more small loops, and one or more large loops.

6. The underseat cover of claim 1, wherein said attachment mechanism comprises the hook material of a hook and loop fastener.

7. The underseat cover of claim 1, wherein said attachment mechanism comprises:
a first attachment strap;
a second attachment strap; and
a closing mechanism selected from the group consisting of magnets, snaps, buckles, and a hook and loop fastener.

8. The underseat cover of claim 1, wherein said attachment mechanism comprises:
an anchor comprising at least one pair of attachment straps, a closing mechanism for said at least one pair of attachment straps, and a release mechanism;
wherein said at least one pair of attachment straps is configured to secure said anchor to a seat bottom frame and said release mechanism is configured to allow said anchor to be in removeable communication with said panel of protective material.

9. The underseat cover of claim 1, further comprising a side storage unit.

10. The underseat cover of claim 1, further comprising a debris catch in communication with said panel of protective material and in removeable communication with a second underseat cover;
wherein said debris catch is configured to extend across a gap between said panel of protective material and said second underseat cover.

11. The underseat cover of claim 10, wherein said debris catch further comprises a first catch end and a second catch end;
said first catch end of said debris catch extending a first distance below said panel of protective material and said second catch end of said debris catch extending a second distance below said panel of protective material, wherein said second distance is greater than said first distance.

12. The underseat cover of claim 1, further comprising a cover extension;
said cover extension comprising a first cover end and a second cover end;
said first cover end in communication with said panel of protective material.

13. The underseat cover of claim 12, further comprising a weighted strip;
said weighted strip in communication with said second cover end of said cover extension.

14. The underseat cover of claim 13, further comprising a second weighted strip, said second weighted strip proximate to said first cover end of said cover extension.

15. The underseat cover of claim 12, further comprising a cover attachment mechanism in communication with said second cover end;
said cover attachment mechanism comprising the hook material of a hook and loop fastener.

16. The underseat cover of claim 12, further comprising a cover attachment mechanism in communication with said second cover end;
said cover attachment mechanism comprising a first cover attachment strap, a second cover attachment strap, and a cover attachment closing mechanism selected from the group consisting of magnets, snaps, buckles, and a hook and loop fastener.

17. The underseat cover of claim 12, further comprising a cover attachment mechanism in communication with said second cover end, said cover attachment mechanism comprising:
a cover anchor comprising at least one pair of cover anchor attachment straps, a cover attachment closing mechanism for said at least one pair of cover anchor attachment straps, and a cover anchor release mechanism;
wherein said at least one pair of cover anchor attachment straps is configured to secure said cover anchor to a seat frame and said cover anchor release mechanism is configured to allow said cover anchor to be in removeable communication with said second cover end.

18. The underseat cover of claim 1, further comprising a skirt;
said skirt in communication with at least a portion of said perimeter of said panel of protective material;
said skirt extending away from said first side of said panel of protective material.

19. An underseat cover for folding seat bottoms comprising:
a first panel of protective material comprising a first panel first side, a first panel second side, and a first panel perimeter;
a second panel of protective material comprising a second panel first side, a second panel second side, and a second panel perimeter;
a first panel reinforcement stitching and a second panel reinforcement stitching;
a first panel attachment mechanism and a second panel attachment mechanism; and
a first panel seatbelt relief, a first panel hinge relief, a second panel seatbelt relief and a second panel hinge relief;
wherein said first panel first side and said second panel first side are comprised of a non-permeable material, said first panel perimeter and said second panel perimeter are configured to substantially match a perimeter of a rear seat lower cushion bottom, said first panel reinforcement stitching in communication with said first side of said first panel of protective material and proximate to at least a portion of said first panel perimeter, said second panel reinforcement stitching in communication with said first side of said second panel of protective material and proximate to at least a portion of said second panel perimeter, said first panel seatbelt relief and said second panel seatbelt relief configured to clear a seatbelt buckle, said first panel hinge relief and said second panel hinge relief configured to clear a folding seat bottom hinge, said first panel attachment mechanism in communication with said second side of said first panel and proximate to at least a portion of said first panel perimeter, said second panel attachment mechanism in communication with said second side of said second panel and proximate to at least a portion of said second panel perimeter;
wherein said first panel attachment mechanism and said second panel attachment mechanism comprise the hook portion of a hook and loop fastener; and
wherein said first panel attachment mechanism is in communication with said first panel reinforcement stitching and said second panel attachment mechanism is in communication with said second panel reinforcement stitching.

20. An underseat cover for folding seat bottoms comprising:
a panel of protective material having a first side, and a second side; and a perimeter;
a panel attachment mechanism in communication with said second side of said panel of protective material;
a cover extension having a first cover end and a second cover end;
a cover attachment mechanism; and
a first cover securing strip and a second cover securing strip;
wherein said first cover end is in communication with said perimeter of said panel of protective material, said panel attachment mechanism comprises the hook portion of a hook and loop fastener, said cover attachment mechanism is in communication with said second cover end and comprises the hook portion of a hook and loop fastener, said first cover securing strip is proximate to said first cover end and said second cover securing strip is proximate to said second cover end.

21. The underseat cover of claim 20, wherein said first cover securing strip and said second cover securing strip comprise weighted strips.
